(19) United States
(12) Patent Application Publication
(10) Pub. No.: US 2008/0141112 A1
(43) Pub. Date: Jun. 12, 2008

(54) Document Processing Device and Document Processing Method

(76) Inventor: Jumpei Aoki, Tokushima (JP)

Correspondence Address: SUGHRUE MION, PLLC, 2100 PENNSYLVANIA AVENUE, N.W., SUITE 800, WASHINGTON, DC, 20037, US

(21) Appl. No.: 11/576,239

(22) PCT Filed: Oct. 27, 2005
(86) PCT No.: PCT/JP05/19824

§ 371 Date: Dec. 7, 2007

(30) Foreign Application Priority Data
Oct. 27, 2004 (JP) 2004-312835

(51) Int. Cl. G06F 17/00

(52) U.S. Cl. 715/234

(57) ABSTRACT

The namespace of a document described in a markup language is identified.

A namespace detection unit 310 reads out an XML document to be processed, and detects a line where the namespace is described. In a case that no correct namespace has been identified, the namespace identifying unit 312 searches for and identifies the namespace while inquiring of a namespace information storage unit 316. A namespace display unit 314 displays the namespace thus identified or namespace candidates. In the latter case, the namespace candidates are displayed in a manner that allows the user to select one from among the namespace candidates. The namespace information storage unit 316 stores beforehand the information with respect to the relation between the namespace and the filename extension of an XML document, or character strings such as the tag names described in the document, which serves as a key for identifying the namespace.

### TECHNICAL FIELD

The present invention relates to a document processing technique, and particularly to a document processing apparatus and a document processing method for processing a structured document having a hierarchical structure.

### BACKGROUND ART

XML (eXtensible Markup Language) has been attracting attention as a data description format that allows the user to share data with other users via a network. This has promoted the development of applications for creating, displaying, and editing XML documents (see Patent document 1, for example). XML documents are created based upon a vocabulary (tag set) defined according to a document type definition.

XML permits the user to use multiple vocabularies in a single document. However, in some cases, such multiple vocabularies have the same element names or the same attribute names. In such a case, different elements having the same element name or different attributes having the same attribute name clash with one another. That is to say, this leads to a problem in that the vocabulary to which the element type or the attribute type belongs cannot be identified. In order to solve such a problem, XML uses the “namespace” concept, in which the namespace describes the vocabulary to which the element types and the attribute types used in a document belong.

### [Patent Document 1]

Japanese Patent Application Laid-open No. 2001-290804

### DISCLOSURE OF INVENTION

### Problems to be Solved by the Invention

However, in some cases, a situation can occur in which the namespace has not been described properly. Accordingly, there is a demand for a technique for supporting the proper processing of a document even if such a situation has occurred.

The present invention has been made in view of the aforementioned problems. Accordingly, it is an object of the present invention to provide a technique for performing proper processing for a structured document even if information such as the namespace cannot be identified, thereby allowing such a document to be displayed and edited smoothly.

### Means for Solving the Problems

An aspect of the present invention relates to a document processing apparatus. The document processing apparatus comprises: a namespace detection unit which detects a namespace to which elements included in a document described in a markup language belong; a namespace identifying unit that provides a function whereby, in a case that the namespace detection unit has not detected any correct namespace, keywords are extracted from the document based upon a predetermined condition, and the namespace is identified based upon the keywords thus extracted; and a namespace information storage unit which stores information with respect to the relation between the keywords and the namespace. With such an arrangement, the namespace identifying unit identifies the namespace based upon the extracted keywords with reference to the namespace information storage unit. Furthermore, the document is displayed, in a manner that allows a user to edit the document, based upon the namespace thus identified by the namespace detection unit or the namespace identifying unit.

The “markup language” may be a kind of XML, e.g., XHTML (eXtensible HyperText Markup Language), SVG (Scalable Vector Graphics), MathML (Mathematical Markup Language), etc. Also, examples of the markup languages include SGML (Standard Generalized Markup Language), HTML (HyperText Markup Language), etc. Examples of the keywords include: a filename extension included in the file name of a document; an element name (tag name) or an attribute name described in the document; etc., which allow the namespace to be conjectured.

Also, the document processing apparatus may further comprise a namespace display unit which displays multiple namespaces detected by the data name identifying unit, and which allows the user to select one from among the multiple namespace candidates, thereby identifying the namespace. Also, the namespace information storage unit may store the information with respect to the relation between the namespace to which the elements included in the document belong and the keywords included in the document, for the past documents that have been processed every time the document is processed. With such an arrangement, the namespace may be identified based upon the information thus stored.

Another aspect of the present invention relates to a document processing method. The document processing method comprises: a step for detecting a namespace to which elements included in a document described in a markup language belong; a step whereby, in a case that no correct namespace has been detected in the detection step, keywords are extracted from the document based upon a predetermined condition, and the namespace is identified with reference to information with respect to the relation between the keywords and the namespace stored beforehand; and a step for displaying the document, in a manner that allows a user to edit the document, based upon the namespace thus detected or identified.

Note that any combination of the aforementioned components or any manifestation of the present invention realized by replacement of a system, a recording medium, and so forth, is effective as an embodiment of the present invention.

### ADVANTAGES

The present invention provides a technique for supporting appropriate processing for an structured document.

### BRIEF DESCRIPTION OF THE DRAWINGS

FIG. 1 is a diagram which shows a configuration of a document processing apparatus according to the background technique.

FIG. 2 is a diagram which shows an example of an XML document which is a processing target.

FIG. 3 is a diagram which shows an example in which the XML document shown in FIG. 2 is mapped to a table described in HTML.

FIG. 4(a) is a diagram which shows an example of a definition file used for mapping the XML document shown in FIG. 2 to the table shown in FIG. 3.

FIG. 4(b) is a diagram which shows an example of a definition file used for mapping the XML document shown in FIG. 2 to the table shown in FIG. 3.

FIG. 5 is a diagram which shows an example of a screen on which the XML document, which has been described in a marks managing vocabulary and which is shown in FIG. 2, is displayed after having been mapped to HTML according to the correspondence shown in FIG. 3.

FIG. 6 is a diagram which shows an example of a graphical user interface provided by a definition file creating unit, which allows the user to create a definition file.

FIG. 7 is a diagram which shows another example of a screen layout created by the definition file creating unit.

FIG. 8 is a diagram which shows an example of an editing screen for an XML document, as provided by the document processing apparatus.

FIG. 9 is a diagram which shows another example of an XML document which is to be edited by the document processing apparatus.

FIG. 10 is a diagram which shows an example of a screen on which the document shown in FIG. 9 is displayed.

FIG. 11 is a diagram which shows the configuration of a document processing apparatus according to an embodiment.

FIG. 12 is a flowchart which shows a procedure for identifying a namespace.

FIG. 13 is a diagram which shows an example of an XHTML document having no description of the namespace URI.

FIG. 14 is a diagram which shows an example of a structure of a table which provides a relation between the filename extension and the namespace.

FIG. 15 is a diagram which shows an example of an XHTML document having a description of the namespace URI.

FIG. 16 is a diagram which shows an example of an XML document which has no description of the namespace URI and which uses a diary tag.

FIG. 17 is a diagram which shows an example of an XML document which has a description of the namespace URI and which uses a diary tag.

FIG. 18 is a diagram which shows an example of a style sheet file specified in the XML document shown in FIG. 17.

FIG. 19 is a diagram which shows an example of an XML document that specifies a style sheet.

FIG. 20 is a diagram which shows an example of a style sheet file specified in the XML document shown in FIG. 19.

### REFERENCE NUMERALS

20 document processing apparatus
22 main control unit
24 editing unit
30 DOM unit
32 DOM provider
34 DOM builder
36 output unit
40 CSS unit
42 CSS parser
44 CSS provider
46 rendering unit
50 HTML unit
52, 62 control unit
54, 64 edit unit
56, 66 display unit
60 SVG unit
80 VC unit
82 mapping unit
84 definition file acquisition unit
86 definition file generator
300 document processing apparatus
310 namespace detection unit
312 namespace identifying unit
314 namespace display unit
316 namespace information storage unit

### BEST MODE FOR CARRYING OUT THE INVENTION

Description will be made below regarding the background technique for the present invention before detailed description of the present embodiment.

### (Background Technique)

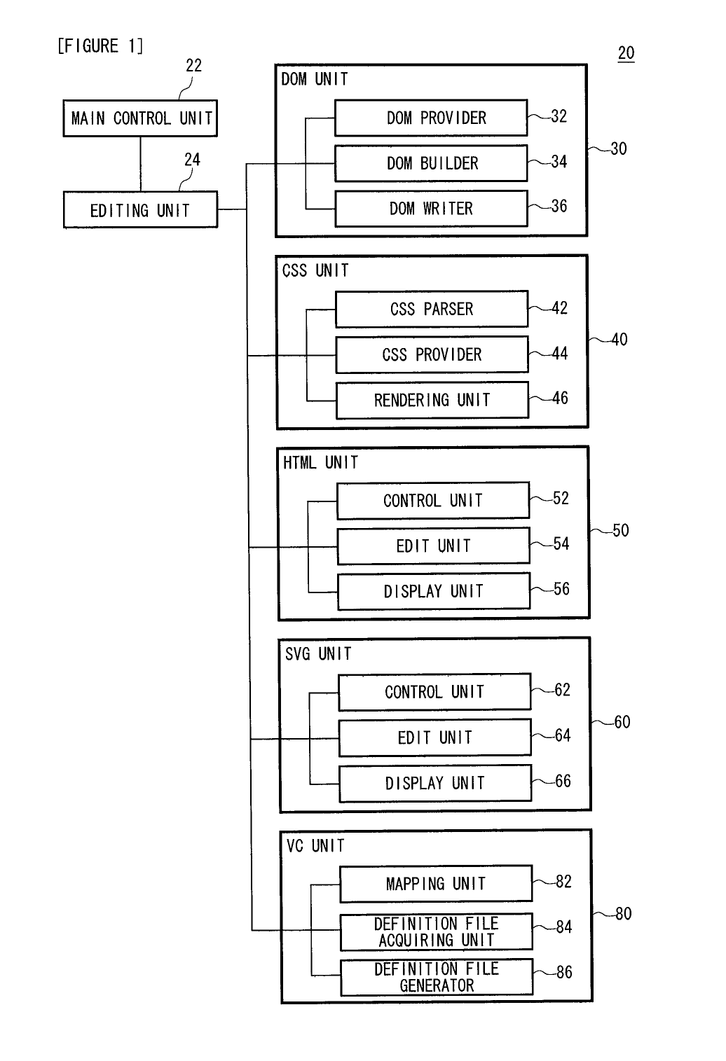

FIG. 1 illustrates a structure of a document processing apparatus 20 according to the background technique. The document processing apparatus 20 processes a structured document where data in the document are classified into a plurality of components having a hierarchical structure. Represented in the background technique is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it would be understood by those skilled in the art that these function blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, the HTML unit 50 and the SVG unit 60 are loaded, respectively. As will be described later, when compound documents, which contain both the HTML and SVG components, are to be processed, both the HTML unit 50 and the SVG unit 60 are loaded.

By implementing the above structure, a user can select so as to install only necessary functions, and can add or delete a function or functions at a later stage, as appropriate. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 generates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are generated. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

The HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the background technique allows an XML document to be edited according to each given vocabulary, as well as providing a function of editing the HTML document in the form of tree display. The HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the background technique, this function is called a vocabulary connection (VC). In the VC unit 80, the definition file acquiring unit 84 acquires a script file in which the mapping definition is described. Here, the definition file specifies the correspondence (connection) between the nodes for each node. Furthermore, the definition file may specify whether or not editing of the element values or attribute values is permitted. Furthermore, the definition file may include operation expressions using the element values or attribute values for the node. Detailed description will be made later regarding these functions. The mapping unit 82 instructs the DOM builder 34 to generate a destination tree with reference to the script file acquired by the definition file acquiring unit 84. This manages the correspondence between the source tree and the destination tree. The definition file generator 86 offers a graphical user interface which allows the user to generate a definition file.

The VC unit 80 monitors the connection between the source tree and the destination tree. Upon reception of an editing instruction from the user via a user interface provided by a plug-in that handles a display function, the VC unit 80 first modifies a relevant node of the source tree. As a result, the DOM unit 30 issues a mutation event indicating that the source tree has been modified. Upon reception of the mutation event thus issued, the VC unit 80 modifies a node of the destination tree corresponding to the modified node, thereby updating the destination tree in a manner that synchronizes with the modification of the source tree. Upon reception of a mutation event that indicates that the destination tree has been modified, a plug-in having functions of displaying/editing the destination tree, e.g., the HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 generates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and generates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

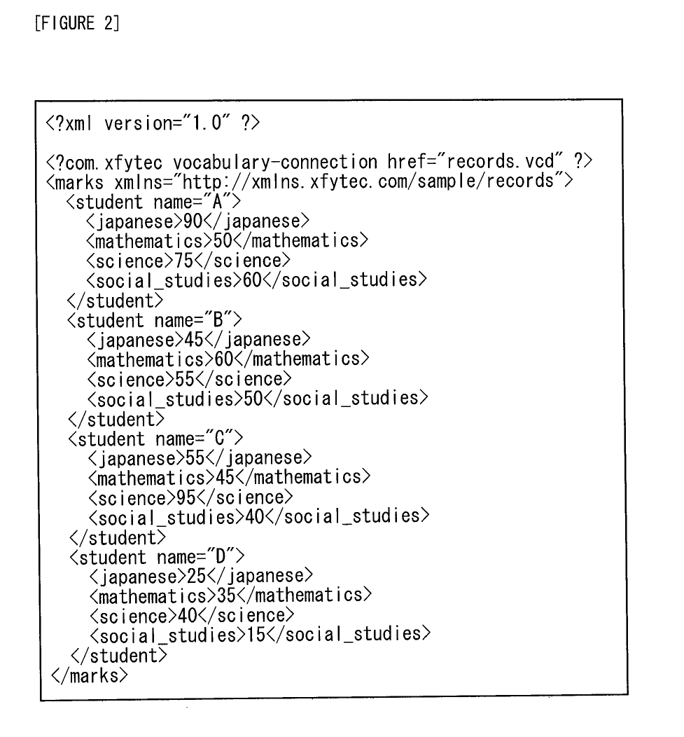

FIG. 2 shows an example of an XML document to be processed. According to this exemplary illustration, the XML document is used to manage data concerning grades or marks that students have earned. A component “marks”, which is the top node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the background technique does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

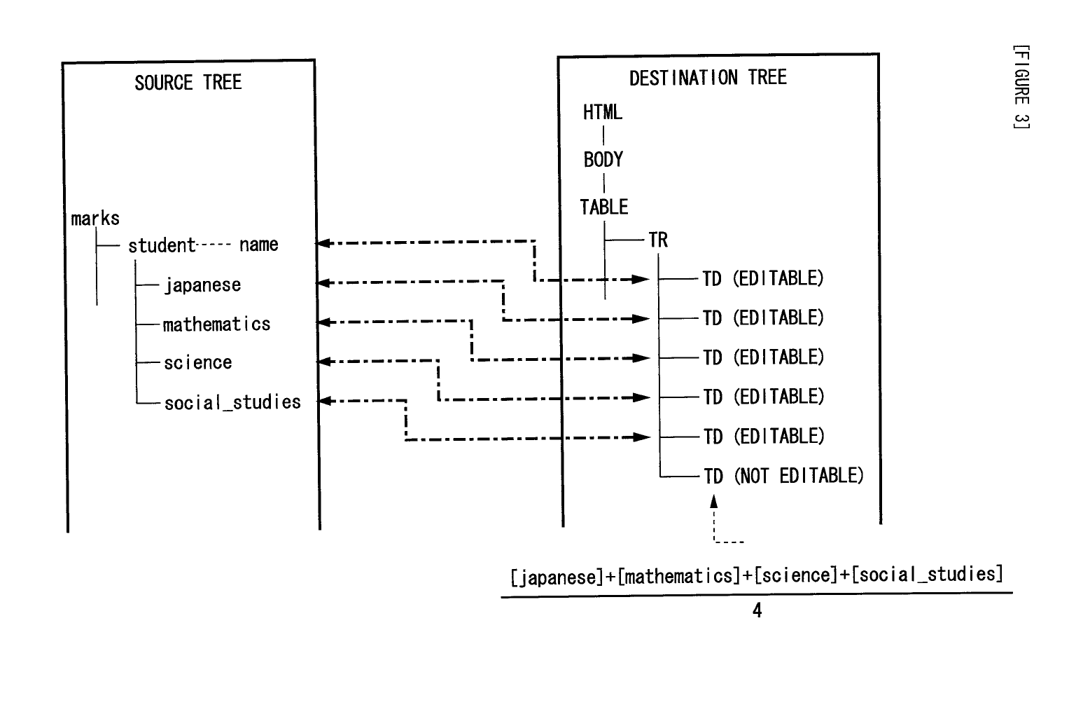

FIG. 3 shows an example in which the XML document shown in FIG. 2 is mapped to a table described in HTML. In an example shown in FIG. 3, a “student” node in the marks managing vocabulary is associated with a row (“TR” node) of a table (“TABLE” node) in HTML. The first column in each row corresponds to an attribute value “name”, the second column to a “japanese” node element value, the third column to a “mathematics” node element value, the fourth column to a “science” node element value and the fifth column to a “social_studies” node element value. As a result, the XML document shown in FIG. 2 can be displayed in an HTML tabular format. Furthermore, these attribute values and element values are designated as being editable, so that the user can edit these values on a display screen using an editing function of the HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

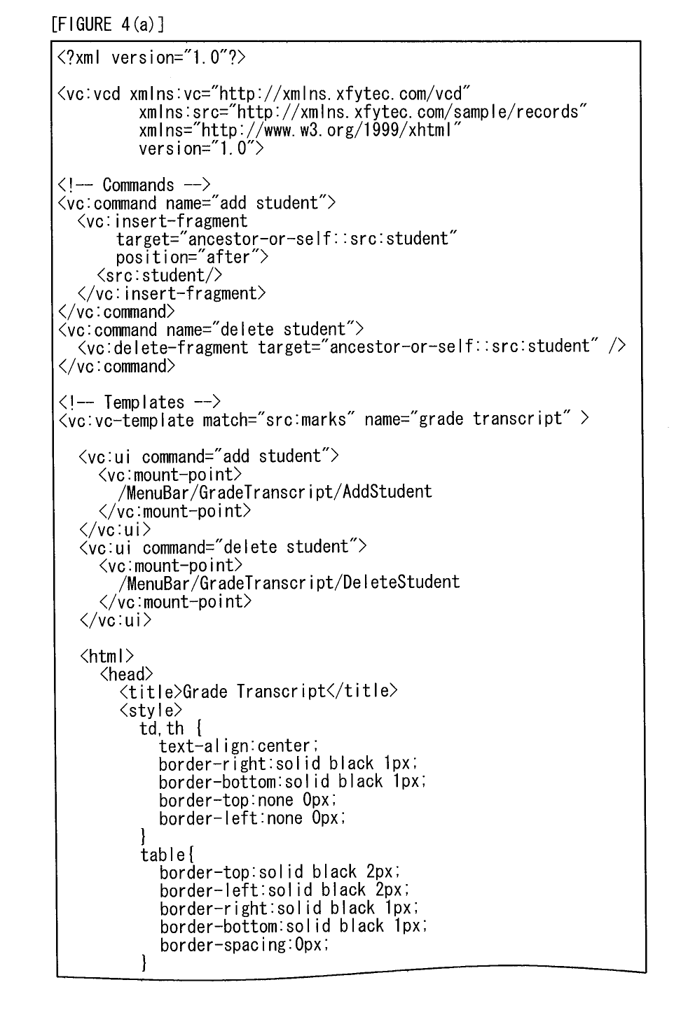

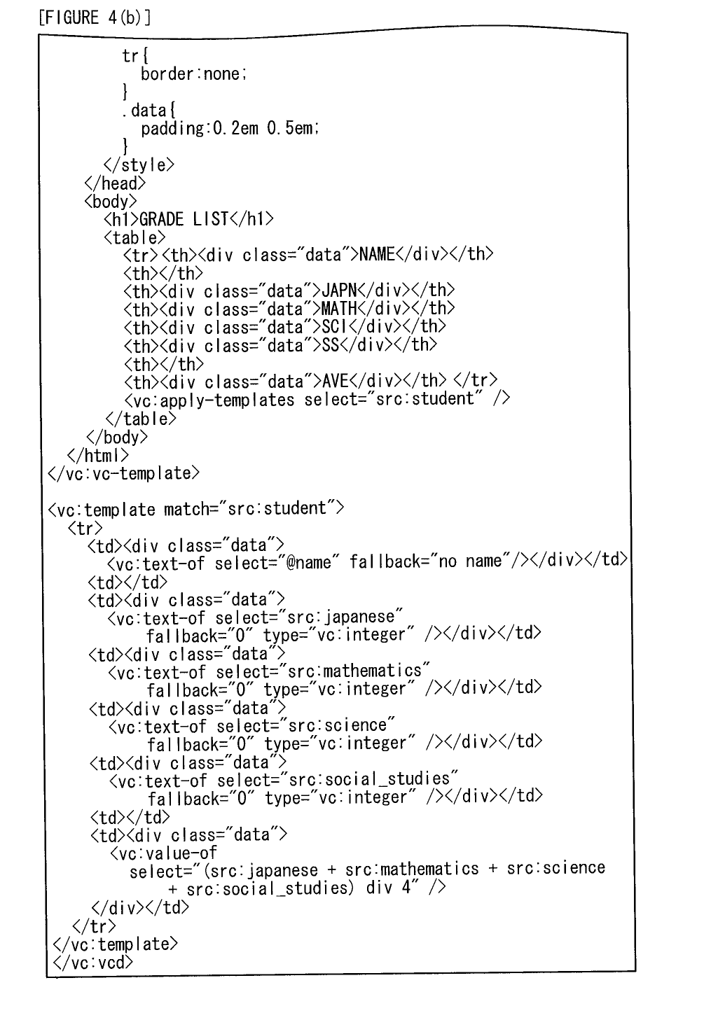

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a node “student” into a source tree and an operation of deleting the node “student” from the source tree, respectively, are associated with these commands. Furthermore, the definition file is described in the form of a template, which describes that a header, such as “name” and “japanese”, is displayed in the first row of a table and the contents of the node “student” are displayed in the second and subsequent rows. In the template displaying the contents of the node “student”, a term containing “text-of” indicates that editing is permitted, whereas a term containing “value-of” indicates that editing is not permitted. Among the rows where the contents of the node “student” are displayed, an operation expression “(src:japanese+src:mathematics+scr:science+scr:social_studies) div 4” is described in the sixth row. This means that the average of the student's marks is displayed.

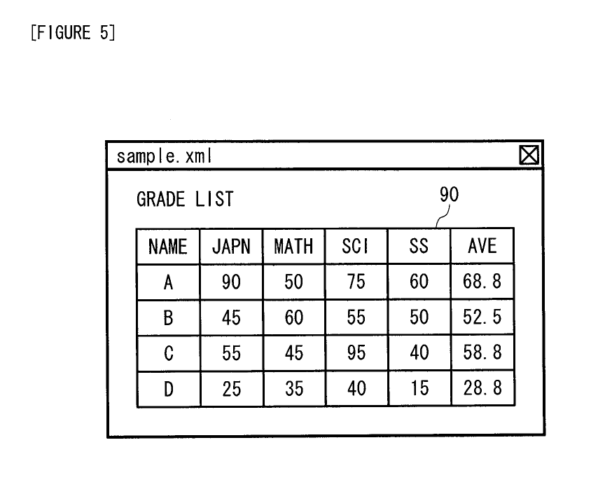

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the name of each student, marks for Japanese, marks for mathematics, marks for science, marks for social studies and the averages thereof. The user can edit the XML document on this screen. For example, when the value in the second row and the third column is changed to “70”, the element value in the source tree corresponding to this node, that is, the marks of student “B” for mathematics are changed to “70”. At this time, in order to have the destination tree follow the source tree, the VC unit 80 changes a relevant portion of the destination tree accordingly, so that the HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a node “student” is added or deleted in the source tree. In this manner, with the document processing apparatus 20 according to the background technique, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of the HTML unit 50.

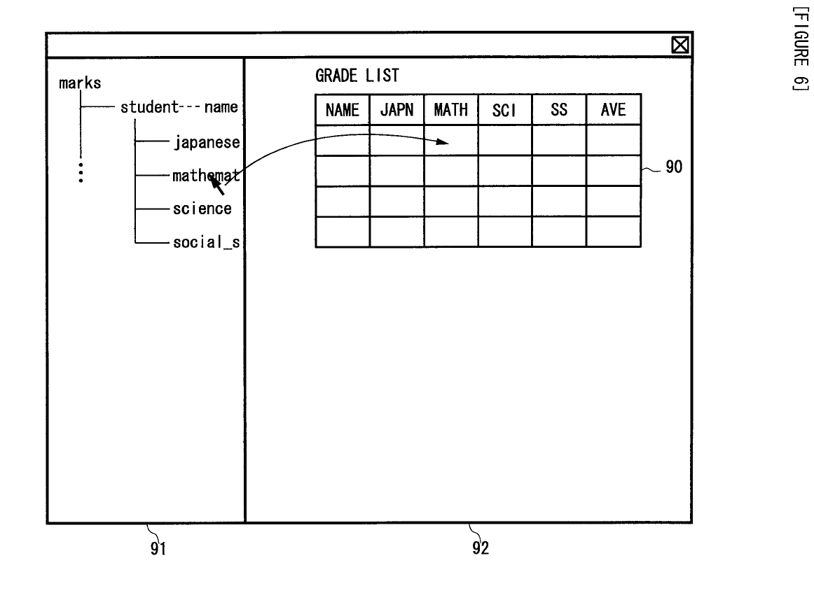

FIG. 6 shows an example of a graphical user interface, which the definition file generator 86 presents to the user, in order for the user to generate a definition file. An XML document to be mapped is displayed in a tree in a left-hand area 91 of a screen. The screen layout of an XML document after mapping is displayed in a right-hand area 92 of the screen. This screen layout can be edited by the HTML unit 50, and the user creates a screen layout for displaying documents in the right-hand area 92 of the screen. For example, a node of the XML document which is to be mapped, which is displayed in the left-hand area 91 of the screen, is dragged and dropped into the HTML screen layout in the right-hand area 92 of the screen using a pointing device such as a mouse, so that a connection between a node at a mapping source and a node at a mapping destination is specified. For example, when “mathematics,” which is a child element of the element “student,” is dropped to the intersection of the first row and the third column in a table 90 on the HTML screen, a connection is established between the “mathematics” node and a “TD” node in the third column. Either editing or no editing can be specified for each node. Moreover, the operation expression can be embedded in a display screen. When the screen editing is completed, the definition file generator 86 generates definition files, which describe connections between the screen layout and nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

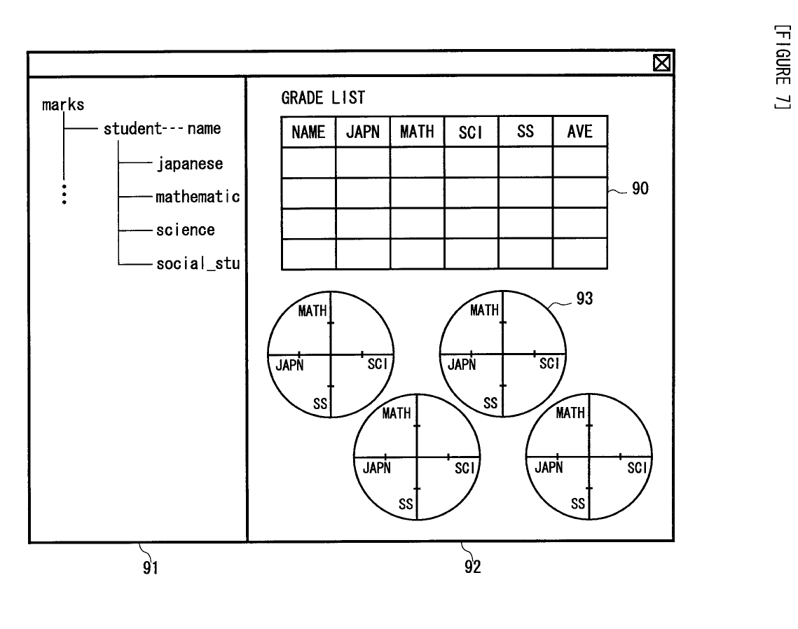

FIG. 7 shows another example of a screen layout generated by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the background technique can process a compound document described in the form of a single XML document according to a plurality of vocabularies. That is why the table 90 described in HTML and the circular graphs 93 described in SVG can be displayed on the same screen.

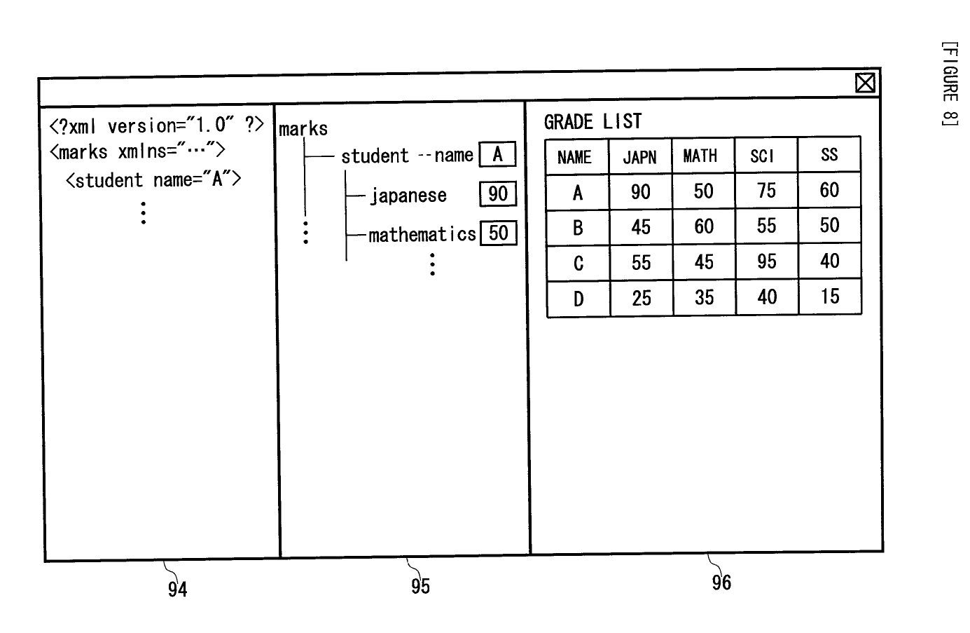

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, the HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to the HTML structure thus laid out, and the HTML unit 50 displays the XML document thus mapped. In such an arrangement, three destination trees in the source format, the tree format and the table format are generated. If the editing is carried out in any of the three areas on the screen, the VC unit 80 modifies the source tree and, thereafter, modifies the three destination trees in the source format, the tree format and the table format. Then, the HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

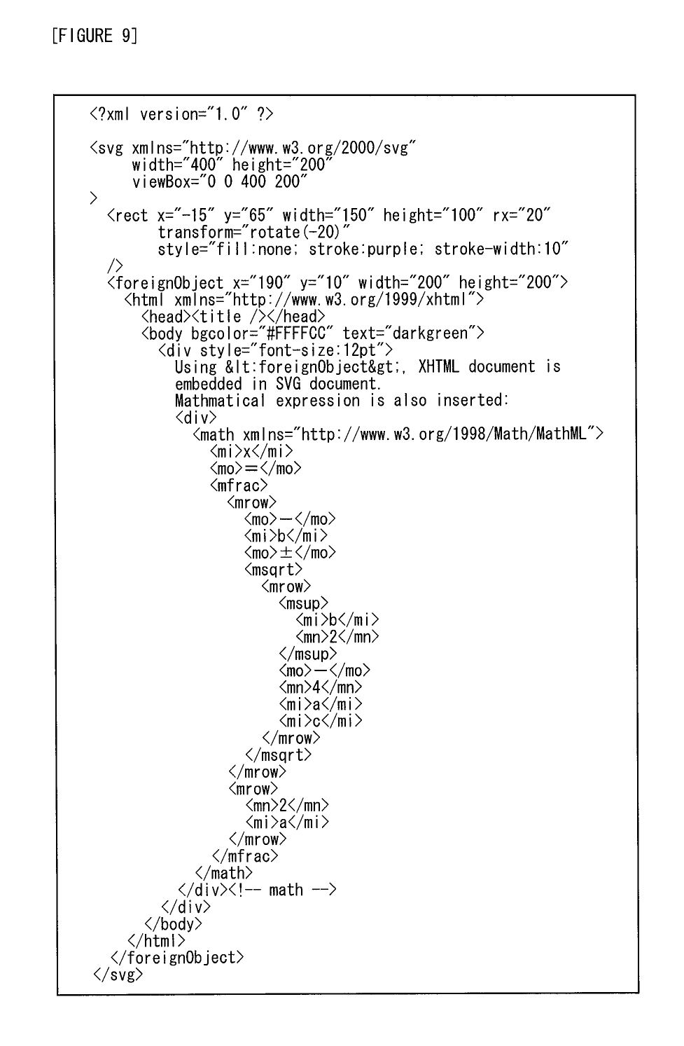

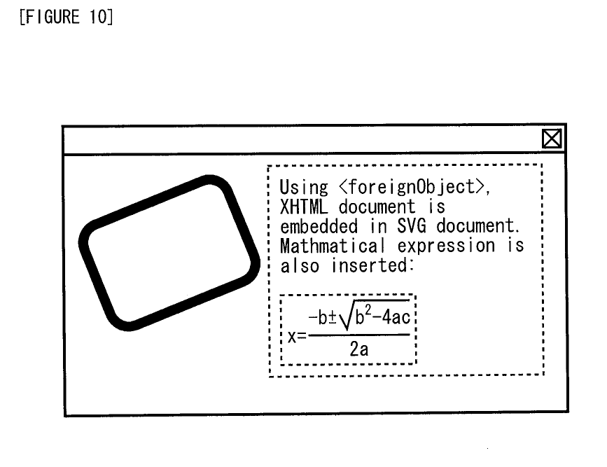

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs the HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by the HTML unit 50, or a command set which is defined in the definition file for mapping the HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the background technique, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the order of importance.

When the user edits a document on an edit screen as shown in FIG. 10, a plug-in or a VC unit 80, which is in charge of processing the edited portion, modifies the source tree. A listener for mutation events can be registered for each node in the source tree. Normally, a display unit of the plug-in or the VC unit 80 conforming to a vocabulary that belongs to each node is registered as the listener. When the source tree is modified, the DOM provider 32 traces toward a higher hierarchy from the modified node. If there is a registered listener, the DOM provider 32 issues a mutation event to the listener. For example, referring to the document shown in FIG. 9, if a node which lies lower than the <html> node is modified, the mutation event is notified to the HTML unit 50, which is registered as a listener to the <html> node. At the same time, the mutation event is also notified to the SVG unit 60, which is registered as a listener in an <svg> node, which lies upper to the <html> node. At this time, the HTML unit 50 updates the display by referring to the modified source tree. Since the nodes belonging to the vocabulary of the SVG unit 60 itself are not modified, the SVG unit 60 may disregard the mutation event.

Depending on the contents of the editing, modification of the display by the HTML unit 50 may change the overall layout. In such a case, the layout is updated by a screen layout management mechanism, e.g., the plug-in that handles the display of the highest node, in increments of display regions which are displayed according to the respective plug-ins. For example, in a case of expanding a display region managed by the HTML unit 50, first, the HTML unit 50 renders a part managed by the HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### EMBODIMENT

Let us say that an information processing apparatus according to an embodiment of the present invention is configured on the basis of the aforementioned background technique, and the information processing apparatus according to the present embodiment has a basic configuration including the document processing apparatus according to the aforementioned background technique in the form of a part of the present embodiment. Now, description will be made in the present embodiment mainly regarding an arrangement that provides a function of processing a document file structured with XML, which is an example of a structured document.

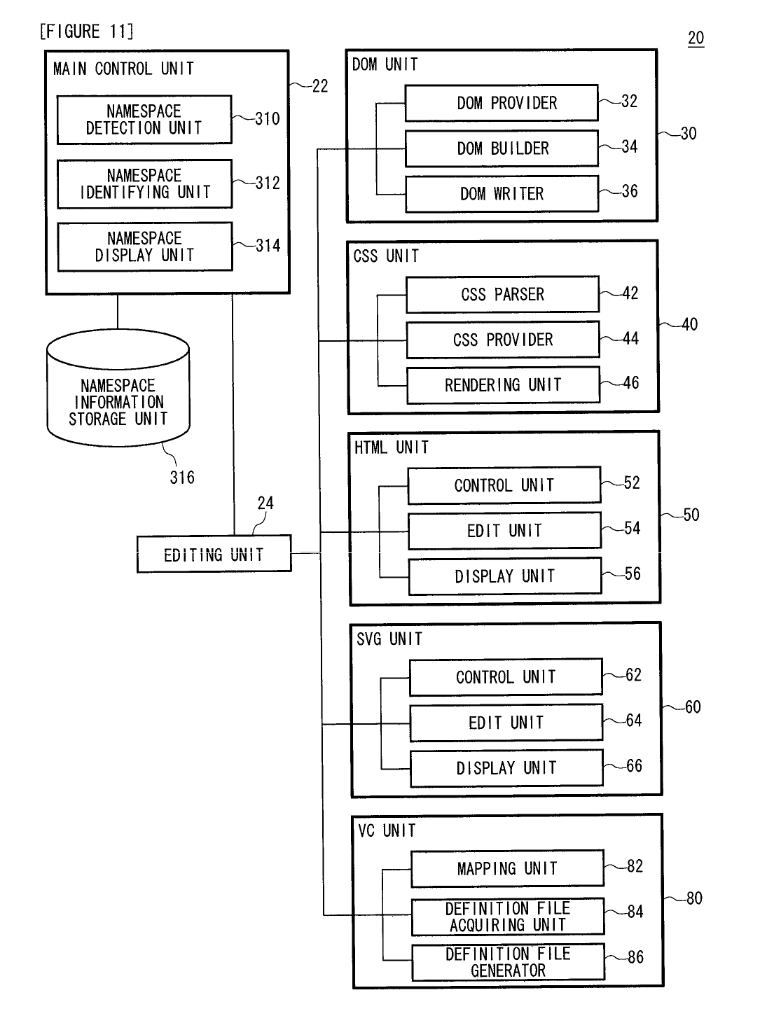

FIG. 11 shows a document processing apparatus 300 according to the present embodiment. In this drawing, the components denoted by the same reference numerals as those shown in FIG. 1 have the same or similar functions as those described above with reference to FIG. 1. A main control unit 22 of the document processing apparatus 300 according to the present embodiment includes a namespace detection unit 310, a namespace identifying unit 312, and a namespace display unit 314, which are new components provided in addition to the components shown in FIG. 1, and are connected to a namespace information storage unit 316. The main control unit 110 includes a namespace detection unit 310 and a namespace identifying unit 312, and is connected to a namespace information storage unit 316. The namespace detection unit 310 reads out an XML document which is a processing target, and detects a line which includes the information that allows the namespace to be identified, e.g., the line where the namespace URI has been described. In a case that the correct namespace has not been detected, e.g., in a case that the information that allows the namespace to be identified has not been detected, or in a case that the namespace URI thus detected is incorrect, the namespace identifying unit 312 receives a signal to that effect from the namespace detection unit 310. Then, the namespace identifying unit 312 detects and identifies the namespace while inquiring of the information storage unit 316. The namespace display unit 314 displays the namespace thus identified, or displays the namespace candidates. In a case that the namespace candidates cannot be identified in the final stage, the namespace display unit 314 may display the XML document in the form of a source file. The namespace information storage unit 316 stores beforehand the information that indicates the relation between the namespace and the character string which serves as a key for identifying the namespace, e.g., the filename extension that is included in the file name of an XML document which is a processing target, or the element name or the attribute name described in the document. The information that indicates such a relation will be described later. Examples of such information include a table in which the file extension “html” is associated with the namespace URI “http://www.w3.org/1999/xhtml”. Description will be made hereafter on the assumption that the namespace information storage unit 316 stores the information that indicates the relation between the namespace and the filename extension or the tag name.

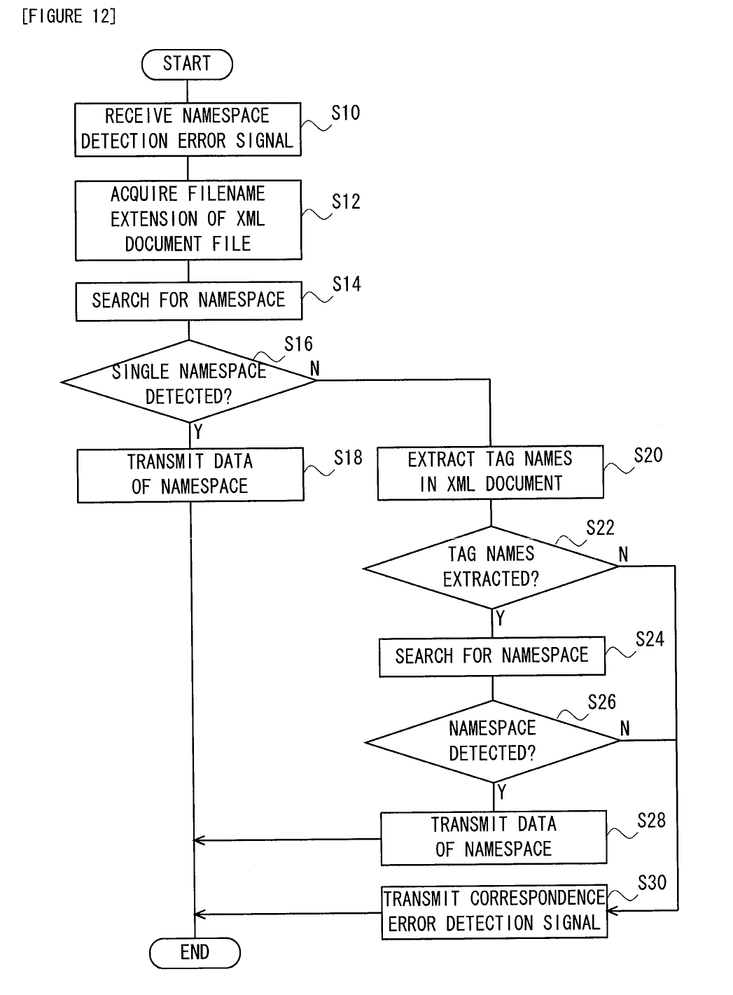

FIG. 12 is a flowchart which shows the procedure executed by the namespace identifying unit 312 for identifying the namespace in cooperation with the namespace information storage unit 316. First, upon reception of a signal from the namespace detection unit 310 to the effect that the correct namespace has not been identified in the processing target XML document (S10), the namespace identifying unit 312 acquires the filename extension from the file name of the XML document which is a processing target (S12). Then, the namespace identifying unit 312 inquires of the namespace information storage unit 316 based upon the filename extension thus acquired so as to search for the namespace which has been associated with the filename extension (S14). In a case that there is only one namespace that corresponds to the filename extension (in a case of “YES” in S16), the data of the namespace is transmitted to the namespace display unit 314 (S18). On the other hand, in a case that the namespace information storage unit 316 stores no namespace that corresponds to the filename extension, or in a case that multiple namespaces have been detected (in a case of “NO” in S16), the namespace identifying unit 312 extracts the element names (tag names) of the elements included in the XML document (S20). Here, the namespace identifying unit 312 may extract the attribute names instead of the tag names. Description will be made hereafter regarding an arrangement employing the tag names as keywords. In a case that the tag names have been extracted (in a case of “YES” in S22), the namespace identifying unit 312 detects the namespace using a predetermined method based upon the tag names thus extracted as described later (S24). In a case that the namespace has been acquired (in a case of “YES” in S26), the data thereof is transmitted to the namespace display unit 314 (S28). On the other hand, in a case that the namespace has not been detected (in a case of “NO” in S26), e.g., in a case that the namespace information storage unit 316 has no stored information with respect to the namespace that corresponds to any one of all the tag names thus extracted, or in a case that no tag name has been extracted (in a case of “NO” in S22), a correspondence error detection signal is transmitted to the namespace display unit 314 (S30).

The namespace display unit 314 may display only one namespace identified by the namespace identifying unit 312, thereby allowing the user to confirm the namespace in the final stage. With such an arrangement, with reference to the namespace thus identified, the main control unit 22 or the editing unit 24 identifies the vocabulary of the XML document, and implements display and editing using a plug-in for displaying or editing that corresponds to the vocabulary. Here, let us consider a case in which the plug-in for processing the vocabulary of the namespace thus identified has not been installed on the aforementioned document processing apparatus. In this case, a message may be displayed for the user so as to prompt the user to load the plug-in. Also, the plug-in may be automatically downloaded.

Such an arrangement has a function of automatically identifying the namespace based upon the filename extension of the file or the element names, the attribute names, or the like, described in the document before the XML document is processed, even if there is no description of the namespace, or even if the description of the namespace is missing or erroneous. This enables the user to perform the document processing smoothly without involving time-consuming operations, e.g., a manual search for the portion where the namespace is missing, a manual search for the namespace, etc. Thus, such an arrangement reduces the time cost involved in the document processing. Furthermore, the present embodiment can be employed as a technique for avoiding the system crashes which often occur in reading out such an XML document. Such an arrangement shows the user the potential sources of such problems, and suggests ways to solve these problems, thereby offering a user-friendly document processing apparatus which is easy to understand.

Let us consider a case in which there are multiple namespace candidates. In this case, the namespace identifying unit 312 may instruct the namespace display unit 314 to display the multiple namespace candidates, instead of automatically performing a final identification of the namespace. For example, description has been made with reference to step S16 shown in FIG. 12 regarding an arrangement in which only one namespace thus detected is determined to be the data to be transmitted in S18. Also, an arrangement may be made in which, in a case that multiple namespace candidates have been detected, the data of the multiple candidates is transmitted to the namespace display unit 314, and all the candidates are displayed. With such an arrangement, the user may select the appropriate namespace, thereby allowing the settings to be made using the namespace thus selected. Also, an arrangement may be made in which the probabilities of the namespace candidates are calculated using a calculation method described later, and some of the higher probability namespaces are displayed.

With such an arrangement, in a case that the namespace is identified based upon multiple keywords such as the filename extension, tag names, etc., the probabilities of the namespaces thus detected are calculated. This improves the precision of the namespace identification. On the other hand, let us consider a case in which the namespace has not been automatically identified. Even in this case, with such an arrangement, the namespace candidates are narrowed down, and the namespace candidates thus narrowed down are displayed for the user. Such an arrangement reduces the number of time-consuming operations required as compared with an arrangement that requires the user to perform manual operations throughout the procedure.

Any combination of searching based upon the filename extension and searching based upon the tag names may be made. Examples of such combinations include: processing in which a first-stage search is performed based upon the tag names; processing in which a search is performed based upon only the filename extension or the tag names; etc. Also, the search key is not restricted to the filename extension, the element name, the attribute name, or the like.

In the processing step, in a case of reception of the correspondence error detection signal from the namespace identifying unit 312, the namespace display unit 314 may display the XML document as-is, i.e., in the form of a source file, and a message advising the user that the namespace has not been detected may be displayed for the user. Also, a description may be inserted so as to allow the user to identify the namespace, for example, thereby allowing the user to directly correct the XML document.

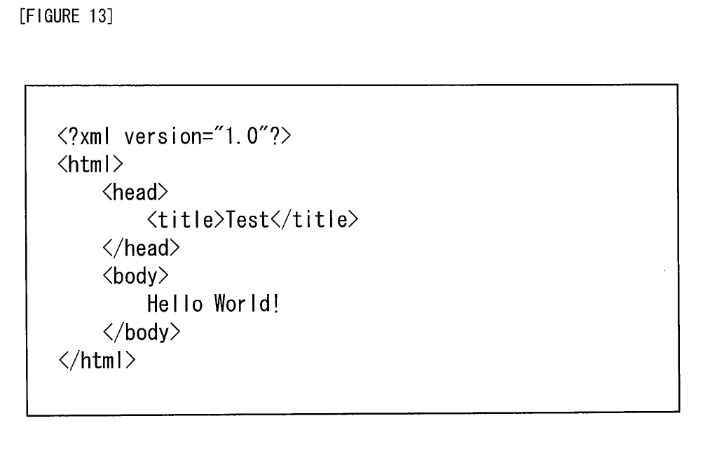

Now, specific description will be made regarding a method used by the namespace identifying unit 312 for identifying the namespace, or for narrowing down the namespace candidates. FIG. 13 shows an example of an XHTML document that does not include a URI, which is the information for identifying the namespace. The document, which is an example shown in FIG. 13, does not include the information for identifying the namespace to which the element types such as <head>, <title>, <body>, etc., belong. Realistically, with such an arrangement in which the namespace is inferred for a common document such as an XHTML document, the namespace is identified using a rule-based technique.

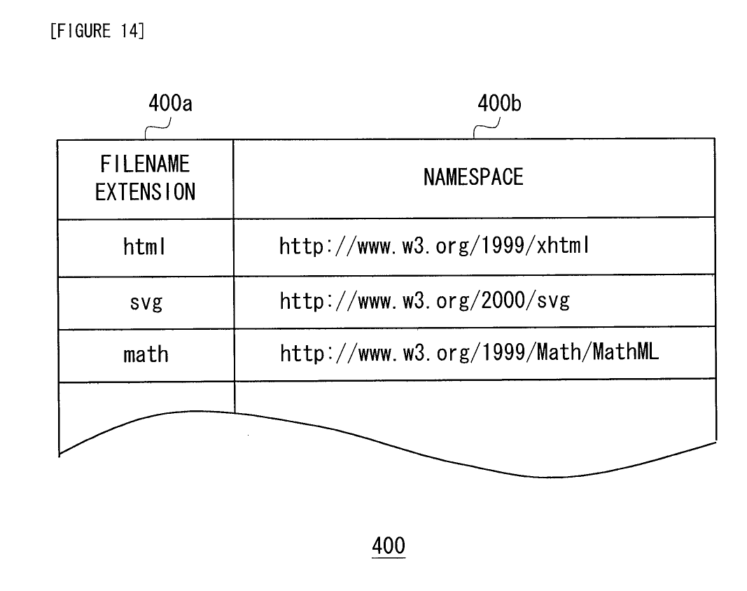

FIG. 14 shows an example of a table structure 400 stored in the namespace information storage unit 316. The table consists of filename extension name fields 400a and namespace information fields 400b. The step for identifying the namespace with reference to this table corresponds to S14 shown in FIG. 12. Let us consider a case in which the name of the processing target document file is “bunsho.html”. In this case, this table is searched based upon the filename extension “html”, thereby identifying that the URI “http://www.w3.org/1999/xhml” indicates the namespace. Such a low calculation cost search method is effective in a case in which the document is a non-compound document provided in the form of a single XML file.

Let us consider a case in which multiple namespaces have been detected as a result of the search using the filename extension, or a case in which no namespace has been detected. In such cases, a rule-based technique may be applied with reference to a table obtained from the table structure 400 shown in FIG. 14 by replacing the filename extension name fields 400a with the tag name fields as the table elements. This step corresponds to S24 shown in FIG. 12. For example, the XML document shown in FIG. 13 includes a tag at the root node for which the tag name is “html”. With such an arrangement, the namespace is identified as “http://www.w3.org/1999/xhml” with reference to a table like that shown in FIG. 14. The user or the system builder creates the table beforehand as shown in FIG. 14, and stores the table thus created in the namespace information storage unit 316.

Let us consider a case in which multiple namespaces have been detected based upon the tag name extracted from the root node. In this case, identification of the namespace may be performed in the same way based upon an element or elements extracted from lower-level classes. With such an arrangement, the namespace information storage unit 316 may store a table including first-layer tag name fields, second-layer tag name fields, and the namespace information fields. In the example of an XHTML document shown in FIG. 13, the first-layer tag name is “html”, and the second-layer tag names are “head”, “title”, and “body”. With such an arrangement, the table stored in the namespace information storage unit 316 is searched so as to identify the namespace. As another example, let us consider a case in which the first-layer tag name is “svg”, and the second-layer tag names are “desc”, “rect”, “polyline”, etc. In this case, such a document can be identified to be a document described in SVG. On the other hand, in a case that the first-layer tag name is “math”, and the second-layer tag names are “mi”, “mo”, and “mfrac”, such a document can be identified to be a document described in MathML. With such an arrangement as described above, the namespace is identified using tag names that have been extracted from an increased number of tag name classes as search keys, thereby improving the precision of identifying the namespace. Furthermore, such an arrangement effectively narrows down the namespace candidates. Description has been made regarding an arrangement in which the number of search keys such as the filename extension, the first-layer tag names, and the second-layer tag names, is gradually increased. Also, the filename extension and the tag names extracted from multiple layers may be employed from the beginning as the search keys. Also, the tag names only may be employed from the beginning as the search keys.

The namespace information storage unit 316 may further include a probability classifier (not shown) which performs learning processing based upon training sets. Upon instructing the document processing apparatus to learn an XML document or the like including a description of the namespace, the probability classifier stores the information with respect to the relation between the tag names described in the document or the filename extension of the file and the namespace which has been used as a reference for processing the document. The probability classifier having a function of learning processing based upon the training sets may employ an existing method such as Bayes's theorem, the SVM (Support Vector Machine), or the like.

Description will be made below regarding a simple example of calculation for narrowing down the namespace candidates using Bayes's theorem. In the first stage, let us consider a case in which the classifier is instructed to learn a file as a training set for determining that a file is an SVG file, which includes one “svg” element, three “desc” elements, and three “rect” elements. Let us say that this training set will be referred to as “classification A”. Then, let us say that the classifier is instructed to learn another file as a training set for determining that a file is a MathML file, which includes one “math” element, four “mi” elements, and two “mfrac” elements. Now, let us say that this training set will be referred to as “classification B”. Furthermore, let us say that a document C is processed, the namespace of which cannot be identified, and which includes three “desc” elements, one “rect” element, and one “mi” element. In this case, the probability that the namespace of the document C is the classification A, and the probability that the namespace of the document C is the classification B, are calculated using Bayes's theorem as follows.

$$\begin{matrix}P ( A \vert C ) = P ( C \& B ) / P ( C ) \\ = P ( B ) \times P ( C \vert A ) / ( P ( A ) \times P ( C \vert A ) + P ( B ) \times P ( C \vert B ) ) \\ = 0.75 \\ P ( B \vert C ) = 0.25\end{matrix}$$

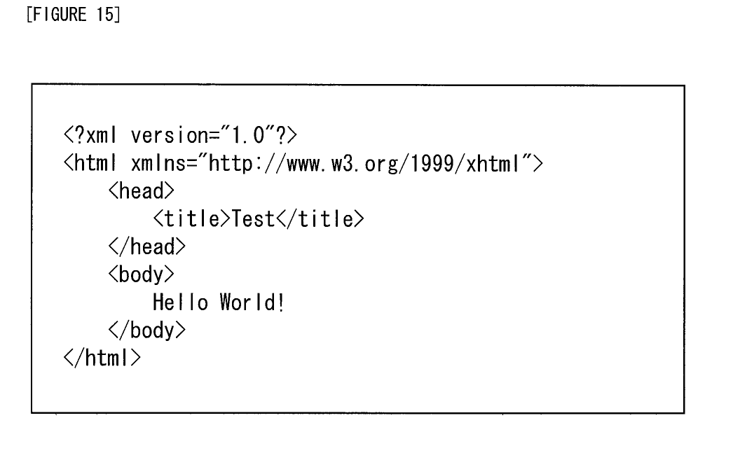

Accordingly, it can be assumed that it is highly probable that the namespace of the document C is that of an SVG document, which is the classification A. For example, with such an arrangement, let us consider a case in which an XHTML document including a description of the namespace URI as shown in FIG. 15 is used beforehand as a training set for the learning processing before the XHTML document shown in FIG. 13 is processed. In this case, the namespace URI is identified to be “http://www.w3.org/1999/xhtml” based upon the results of the probability calculation as described above.

Such a stochastic method as described above provides namespace candidates with probabilities calculated based upon the number of occurrences of the tag names described in the document. Accordingly, an arrangement may be made in which only the top three most probable namespace candidates are displayed on the namespace display unit 314 as the namespace candidates in the final stage. Also, an arrangement may be made in which only the namespace candidates with probabilities higher than 50% are displayed on the namespace display unit 314 as the namespace candidates in the final stage. Also, an arrangement may be made which allows the user to select one from among the namespace candidates, thereby identifying the namespace in the final stage.

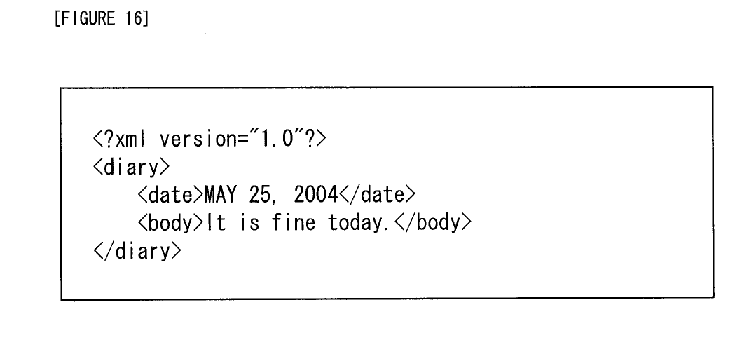

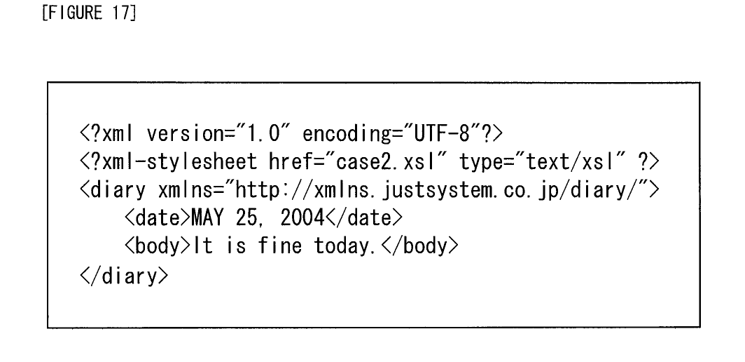

FIG. 16 shows an example of an XML document which uses a diary tag, and which includes no description of the namespace URI. In this case, performance of the above-described stochastic method, after the document processing apparatus has been instructed to learn an XML document including a description of a namespace URI as shown in FIG. 17, is effective for identifying such a unique vocabulary. With such an arrangement, the document processing apparatus is instructed to learn all the past documents that have been processed, each of which includes an description of the namespace identification information. For each document processing apparatus, such an arrangement provides results of probability calculation that correspond to how the user tends to perform document processing. This effectively narrows down the namespace candidates.

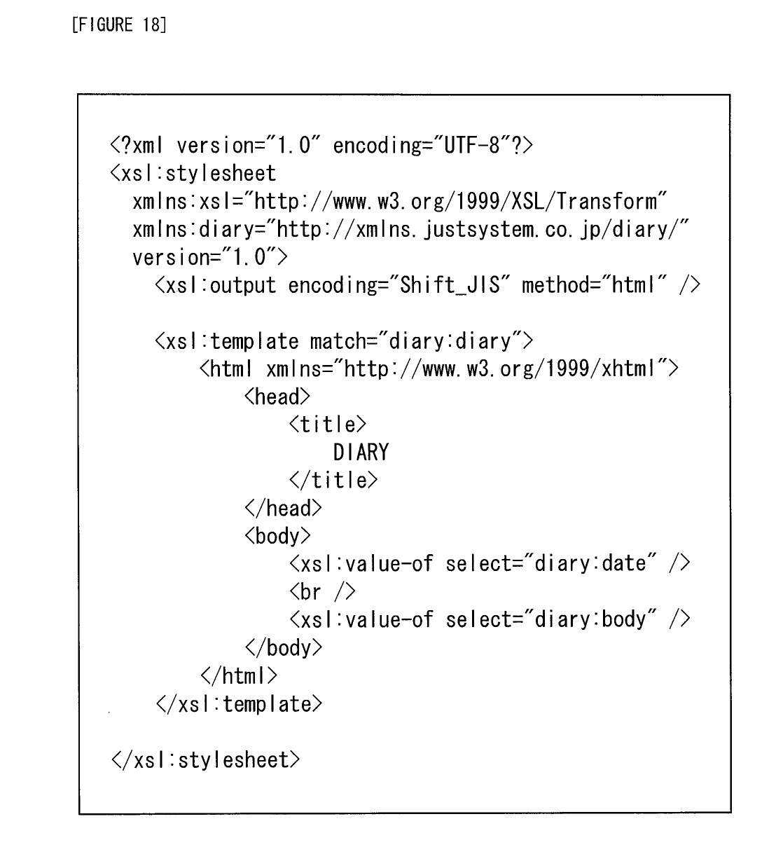

The identifying methods as described above may be applied, without any modification, to documents described in other languages such as XSL (eXtensible Stylesheet Language) etc. in addition to XML documents. Description will be made with reference to an example. First, FIG. 18 shows the contents of an XML stylesheet file “case2.xsl” specified by the XML document shown in FIG. 17. In this case, the namespace URI “http://xmlns.justsystem.co.jp/diary” is described in “case2.xsl”. Accordingly, the XML document shown in FIG. 17 can be smoothly displayed and edited.

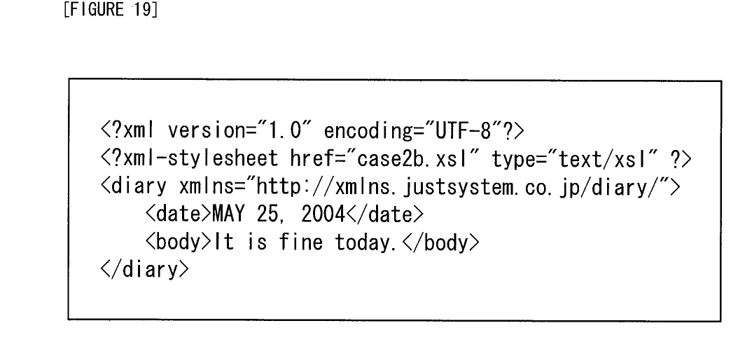

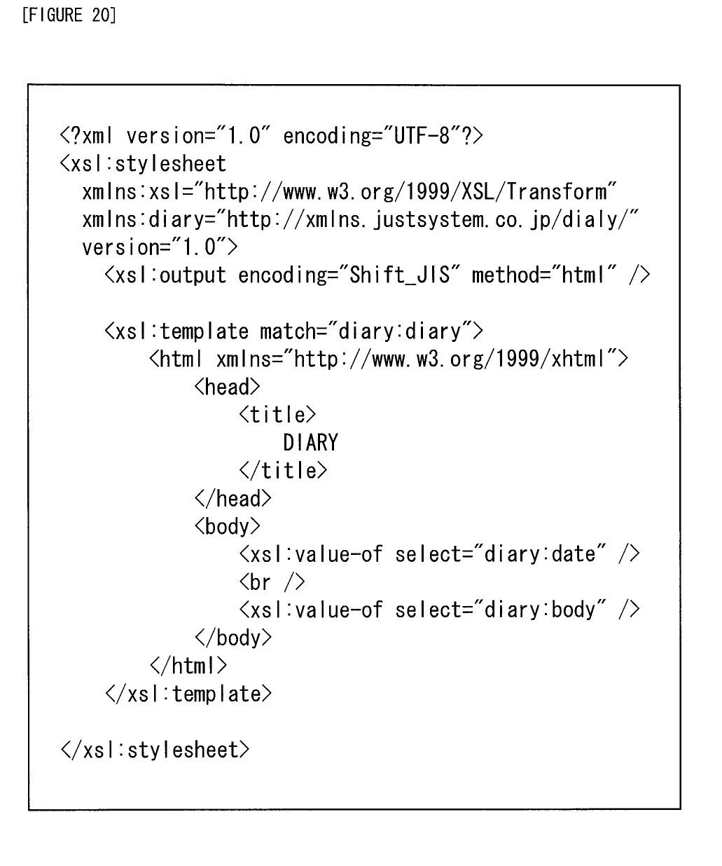

On the other hand, FIG. 19 shows another example of an XML document, which is similar to the document shown in FIG. 17. Here, “case2b.xsl” is specified as the stylesheet file. FIG. 20 shows the contents of the stylesheet file “case2b.xsl”. In comparison with the stylesheet file “case2.xls” shown in FIG. 18, the stylesheet shown in FIG. 20 includes a description of the namespace URI “http://xmlns.justsystem.co.jp/dialy”, which includes an incorrect spelling of the word “diary”. In a case of a document file including incorrect identification information, the namespace identifying unit 312 may search for a namespace having a similar spelling. With such an arrangement, the namespace information storage unit 316 may store a namespace list beforehand. Furthermore, an arrangement may be made in which the namespace having a spelling that exhibits the highest similarity to such an incorrect spelling is detected. With such an arrangement, the similarity may be determined using an existing method such as a method that enumerates the edit distance (Levenshtein distance) or the like.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention. Some of such possible modifications will be listed below.

Description has been made in the embodiment regarding an arrangement for processing an XML document. Also, the document processing apparatus 300 has a function of processing other markup languages, e.g., SGML, HTML, etc.

Description has been made in the aforementioned embodiment regarding an arrangement in which, after the namespace has been identified, a plug-in that corresponds to the vocabulary thereof is loaded, thereby allowing a document to be processed normally, i.e., to be displayed and edited. Also, an arrangement may be made in which plug-in candidates are displayed for the user according to a similar procedure instead of displaying the namespace candidates, and the document is displayed and edited using a plug-in selected by the user.

### INDUSTRIAL APPLICABILITY

The present invention can be applied to an apparatus for processing a structured document.

1. A document processing apparatus comprising:
a namespace detection unit which detects a namespace to which elements included in a document described in a markup language belong;
a namespace identifying unit that provides a function whereby, in a case that said namespace detection unit has not detected any correct namespace, keywords are extracted from the document based upon a predetermined condition, and the namespace is identified based upon the keywords thus extracted; and
a namespace information storage unit which stores information with respect to the relation between the keywords and the namespace,
wherein said namespace identifying unit identifies the namespace based upon the extracted keywords with reference to said namespace information storage unit,
and wherein the document is displayed, in a manner that allows a user to edit the document, based upon the namespace thus identified by said namespace detection unit or said namespace identifying unit.

2. A document processing apparatus according to claim 1, wherein the keyword is a filename extension included in the file name of the document.

3. A document processing apparatus according to claim 1, wherein the keywords are element names or attribute names of the elements.

4. A document processing apparatus according to claim 1, further comprising a namespace display unit which displays a plurality of namespaces detected by said namespace identifying unit,
wherein said namespace identifying unit allows the user to select one from among said plurality of namespaces, thereby identifying the namespace.

5. A document processing apparatus according to claim 1, wherein said namespace information storage unit stores the information with respect to the relation between the namespace to which the elements included in the document belong and the keywords included in the document, for the past documents that have been processed every time the document is processed.

6. A document processing method comprising:
detecting a namespace to which elements included in a document described in a markup language belong;
extracting, in a case that no correct namespace has been detected in said detecting, keywords from the document based upon a predetermined condition, and identifying the namespace with reference to information with respect to the relation between the keywords and the namespace stored beforehand; and
displaying the document, in a manner that allows a user to edit the document, based upon the namespace thus detected or identified.

7. A computer program product comprising:
a module which detects a namespace to which elements included in a document described in a markup language belong;
a module which extracts, in a case that no correct namespace has been detected in said detecting, keywords from the document based upon a predetermined condition, and identifies the namespace with reference to information with respect to the relation between the keywords and the namespace stored beforehand; and
a module which displays the document, in a manner that allows a user to edit the document, based upon the namespace thus detected or identified.
